(19) United States
(12) Patent Application Publication
(10) Pub. No.: US 2024/0386317 A1
(43) Pub. Date: Nov. 21, 2024

(54) SYSTEMS AND METHODS FOR CONFIGURING AND TRAINING MACHINE LEARNING MODELS BASED ON INPUT VALUE CHARACTERISTICS

(71) Applicant: PAYPAL, INC., San Jose, CA (US)

(72) Inventor: Xidong Chen, Shanghai (CN)

(21) Appl. No.: 18/320,116

(22) Filed: May 18, 2023

(51) Int. Cl. G06N 20/00

(52) U.S. Cl. CPC G06N 20/00

(57) ABSTRACT

There are provided systems and methods for configuring and training a machine learning model based on data characteristics associated with input data usable for the machine learning model. First measures are derived for the machine learning model based the input data usable for the machine learning model. The first measures represent data characteristics associated with the input data. The first measures are compared against measures associated with other previously built machine learning models. Based on a comparison, a particular previously built machine learning model having data characteristics most similar to the data characteristics calculated for the machine learning model is selected. A machine learning model configuration setting and training parameters may be determined based on the particular previously built machine learning model. The machine learning model is configured and trained based on the configuration setting and training parameters.

### TECHNICAL FIELD

The present application generally relates to configuring and training a machine learning model, and more specifically, to predicting optimal parameters for configuring and training the machine learning model based on characteristics of prospective input values.

### BACKGROUND

Machine learning models have been widely used to perform various tasks for different reasons. For example, machine learning models may be used in classifying transactions (e.g., determining whether a transaction is a legitimate transaction or a fraudulent transaction, etc.), to predict a value (e.g., an insurance cost) for a consumer, or any other task. In order to implement a machine learning model to perform a specific task, a configuration and training process is typically required. During the configuration and training process, a particular machine learning model type (e.g., an artificial neural network, a gradient boosting tree, a transformer, a natural language processing (NLP) model, etc.) may be selected to implement the machine learning model based on a set of configuration parameters (e.g., a number of hidden layers within an artificial neural network, a number of models within each level of a gradient boosting tree, etc.). Furthermore, training parameters (e.g., hyperparameters for training an artificial neural network, etc.) may be determined for training the machine learning model.

Conventionally, a machine learning model configuration and training process requires an experimental phase, during which various types of machine learning models, various configuration parameters, and various training parameters may be experimented with for configuring and training the machine learning model based on different assumptions. By iteratively configuring and training the machine learning model using different machine learning model types, different configuration parameters, and different training parameters, and subsequently evaluating the performance of the machine learning model in each iteration, a particular machine learning model type, a particular set of configuration parameters, and a particular set of training parameters may be determined to be most suitable to configure and train the machine learning model. For example, the selected machine learning model type and other parameters may enable the machine learning model to produce the most accurate prediction result based on the experimentations of different configurations. However, experimenting with the different possible machine learning model types and parameters can be time-consuming and computationally expensive (e.g., consuming a large amount of computer processing power and memory usage, etc.). As such, there is a need for more efficiently determining an optimal configuration and parameters for configuring and training a machine learning model.

### BRIEF DESCRIPTION OF THE DRAWINGS

FIG. 1 is a block diagram illustrating an electronic transaction system according to an embodiment of the present disclosure;

FIG. 2 is a block diagram illustrating an example machine learning model configuration and training system according to an embodiment of the present disclosure;

FIG. 3 illustrates an example measure generating module according to an embodiment of the present disclosure;

FIG. 4 illustrates an example grouping module according to an embodiment of the present disclosure;

FIG. 5 illustrates an example data flow for calculating a set of measures according to an embodiment of the present disclosure;

FIG. 6 is a flowchart showing a process of configuring and training a machine learning model according to an embodiment of the present disclosure; and

FIG. 7 is a block diagram that illustrates an example of a computing device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for configuring and training a machine learning model based on characteristics of prospective input values for the machine learning model. As discussed above, in order to implement a machine learning model for performing a specific task (e.g., classifying a transaction, predicting a health insurance cost for a consumer, etc.), a conventional process may include an experimental phase, during which various machine learning model types and various parameters (e.g., configuration parameters, training parameters, etc.) may be experimented with in order to select configuration and training settings and parameters for configuring and training the machine learning model. Different variations of the machine learning model may be generated during this experimental phase, where each variation of the machine learning model is configured using a particular machine learning model type and a particular set of configuration parameters, and trained using a particular set of parameters.

For example, when multiple machine learning model types (e.g., an artificial neural network, a gradient boosting tree, a natural language processing (NLP) model, a transformer, etc.) are available and usable to implement the machine learning model, one or more variations of the machine learning model may be configured using a first machine learning model (e.g., an artificial neural network), one or more variations of the machine learning model may be configured using a second machine learning model (e.g., a transformer), and so forth. When multiple variations of the machine learning model are implemented using the same machine learning model type (e.g., an artificial neural network), each variation may be configured using a different set of configuration parameters and trained using a different set of training parameters (e.g., a different set of hyperparameters, etc.).

The different variations of the machine learning model are then tested and evaluated to determine their respective performance (e.g., accuracy performance). Based on the evaluation, a particular variation (e.g., the variation that has the best performance, etc.) may be selected to be used in implementing the machine learning model in a production environment for use to perform the task. However, it is computer processing and memory usage intensive, and time-consuming to generate and test the different variations (e.g., different combinations of machine learning model types and parameters) of the machine learning model.

As such, according to various embodiments of the disclosure, a machine learning model configuration framework is provided to reduce the computation processing and memory usage when configuring a machine learning model. Using the machine learning model configuration framework to build the machine learning model, a machine learning (ML) system may determine a particular machine learning model configuration (e.g., a particular machine learning model type and a particular set of machine learning model configuration parameters) and a particular set of training parameters for the machine learning model based on data characteristics of the input data (e.g., prospective input data) of the machine learning model without having to create different variations of the machine learning model and evaluating them one-by-one. As such, the conventional experimental phase can be completely eliminated when building the machine learning model using the disclosed machine learning model configuration framework, thereby substantially reducing the computation processing and memory usage required for building the machine learning model.

In order to build a machine learning model for performing a specific task, a set of input features that are relevant to the specific task (e.g., features needed to complete the task within a desired accuracy threshold) may be determined. For example, when the specific task is associated with classifying a transaction as a fraudulent transaction or a non-fraudulent transaction, the relevant input features may include a network address (e.g., an Internet Protocol address) of a device used to initiate the transaction, an amount associated with the transaction, a transaction type, a transaction processing history associated with an account, a time of the day when the transaction is initiated, and other relevant attributes. The ML system may configure the machine learning model to accept input data corresponding to the determined input features for performing the specific task.

The Applicant has appreciated that characteristics of the input data usable by the ML system to perform the specific task can be a factor in determining configuration and training parameters for the machine learning model, such that the machine learning model that is configured and trained based on the configuration and training parameters would have an acceptable accuracy performance (e.g., exceeding an accuracy threshold, etc.). It is because other attributes such as the type of task that the machine learning model is configured to perform, while important to the entity (e.g., the organization, the person, etc.) that builds the machine learning model, are typically irrelevant to the machine learning model since the machine learning model does not understand (or is unaware of) the task other than the input data that it is asked to process, and the output that it is asked to generate. As such, what is relevant to the machine learning model is the type of input data being provided to the machine learning model and how the input data is varied across the different datasets (e.g., the characteristics of the input data). The characteristics of the input data would determine how well (e.g., how accurate) the machine learning model can generate the output. Thus, according to various embodiments of the disclosure, the ML system may determine the characteristics of the input data usable by the machine learning model, and may determine the configuration and training parameters for the machine learning model based on the characteristics of the input data. The ML system may then configure the machine learning model based on the configuration parameters and train the machine learning model based on the training parameters.

In some embodiments, the ML system may derive data characteristics (also referred to as “measures”) for each input feature determined for the machine learning model. Using the example illustrated above where the machine learning model is configured to classify transactions as fraudulent transactions or non-fraudulent transactions, the input features may include a network address (e.g., an Internet Protocol address) of a device used to initiate the transaction, an amount associated with the transaction, a transaction type, a transaction processing history associated with an account, a time of the day when and a location where the transaction is initiated, and other relevant attributes. The ML system may obtain multiple datasets usable as input data for the machine learning model, where each dataset may include data values corresponding to the set of input features determined for the machine learning model. As such, each dataset may include a network address value, an amount value associated with a transaction, a transaction type value, a value associated with a transaction processing history of an account, a value representing a time of the day, a value represented a location, and other values.

In some embodiments, the data characteristics (e.g., measures) may be derived based on the values corresponding to each particular input feature across the multiple datasets usable as input data for the machine learning model. The measures may include one or more central tendency measures (e.g., an expectation, a median, a mode, etc.), one or more spread measures (e.g., a range, a quantile, an interquartile range, a variance and standard deviation, etc.), one or more basic statistical measures (e.g., a maximum/a minimum value, a storage type, a dimension, a count, etc.), one or more pattern measures (e.g., symmetrical or asymmetrical, a distribution attribute, etc.), one or more frequency measures (e.g., a ratio, a rate, etc.), one or more outlier measures (e.g., a presence of an outlier, etc.), and/or one or more correlations among different measures.

In some embodiments, the ML system may obtain datasets usable as input data for the machine learning model, and derive the measures for each input feature based on the datasets. In some embodiments, the datasets may include actual data used by the ML system (or another module) to perform the specific task. In some embodiments, the datasets may include training datasets usable to train the machine learning model. The ML system may derive one or more measures for each input feature by analyzing the data values in the datasets that correspond to the input feature. Using the example illustrated above, the ML system may derive one or more measures for the network address input feature, may derive one or more measures for the amount input feature, one or more measures for the transaction type input feature, one or more measures for the transaction processing history input feature, one or more measures for the time of day input feature, and measures for any other input features for the machine learning model.

The ML system may first obtain all of the values corresponding to a first input feature (e.g., extracting the network address values, etc.) from all of the datasets. The ML system may calculate the measures for the network address input feature based on analyzing the values (e.g., determining a mean of the values, determining a range of the values, determining a distribution of the values, etc.). The calculated measures may include one or more central tendency measures, one or more spread measures, one or more basic statistical measures, one or more pattern measures, one or more frequency measures, one or more outlier measures, one or more correlations among the measures, etc. The ML system may also perform the same process to calculate measures for the other input features.

In some embodiments, the ML system may compare the data characteristics (e.g., the measures) derived from the datasets associated with the machine learning model with data characteristics of datasets associated with other machine learning models that have previously been built. Assuming that machine learning models that have been previously built used configuration and training parameters that are optimal for the corresponding machine learning models (e.g., through the experimental process), the configuration and training parameters that work well for a previously built machine learning model may also work well for this machine learning model if the data characteristics associated with the two machine learning models are similar.

For example, the ML system may compare the data characteristics (e.g., measures) associated with the machine learning model to be built (referred to as the “first machine learning model”) against data characteristics associated with the previously built machine learning models. The ML system may then determine, based on the comparisons, whether the data characteristics associated with the first machine learning model are similar to the data characteristics associated with any of the machine learning models that have previously been built, e.g., whether a measure (e.g., the median value) associated with a first input feature of the first machine learning model is similar to the measure associated with a second input feature of the second machine learning model, etc. In some embodiments, by comparing the measures between the first machine learning model and the other machine learning models, the ML system may assign a score to indicate how similar the measures are between two machine learning models. The ML system may then determine which previously built machine learning model (e.g., the second machine learning model) has the highest score, indicating that the data characteristics of such a machine learning model are most similar to the data characteristics of the first machine learning model. The similarity of the measures between two machine learning models may imply that the two machine learning models share one or more common input features, or at least that the input features between the two machine learning models have many common attributes. Due to the similarities of input features and/or the data characteristics between the two machine learning models, the ML system may determine that what works for one of the machine learning models (e.g., the machine learning configuration and training parameters of the second machine learning model) would likely work for the other one of the machine learning models (e.g., the first machine learning model).

It is noted that when comparing the data characteristics between two machine learning models and determining the similarity score, it is not necessary for the two machine learning models to have the same or substantial overlapping input features to have a high similarity score. In some cases, even when the two machine learning models have different input features, as long as the data values corresponding to the input features of the two machine learning models share a substantial amount of characteristics (e.g., the range of the data values corresponding to the input features, the mean of the data values corresponding to the input features, a value distribution of the data values corresponding to the input features, etc.), the ML system may determine a high similarity score for the two machine learning models.

In some embodiments, the ML system may perform a clustering process for the machine learning models (e.g., the first machine learning models and the previously built machine learning models) based on their data characteristics. For example, the ML system may map each of the machine learning models to a vector (or a position) within a multi-dimensional space based on their corresponding data characteristics. The ML system may then group machine learning models with vectors that are within a threshold distance in the multi-dimensional space in the same cluster. In some embodiments, the similarity score for each previously-built machine learning model may be determined based on the distance between the vector associated with the previously-built machine learning model and the vector associated with the first machine learning model (e.g., the shorter the distance, the higher the similarity score, etc.).

As such, using the machine learning model configuration framework as disclosed herein, when the ML system receives a request to build a new machine learning model (e.g., the first machine learning model), the ML system may obtain datasets that are usable as input values for the new machine learning model, compute the data characteristics based on the datasets, and then compare the data characteristics with the data characteristics of any previously-built machine learning models (e.g., using the clustering technique as discussed herein). The ML system may determine which previously-built machine learning model (e.g., the second machine learning model) has data characteristics that are most similar to the data characteristics of the first machine learning model (e.g., has the highest similarity score). The ML system may then obtain configuration and training information associated with the selected previously-built machine learning model (e.g., the second machine learning model), and then apply those configuration and training parameters of the second machine learning models to configure and train the first machine learning model. For example, the ML system may configure the first machine learning model using the same machine learning model type (e.g., an artificial neural network, a gradient boosting tree, etc.) and the same configuration parameters as the second machine learning model, and then train the first machine learning model using the same training parameters used to configure and train the second machine learning model. With a growing number of machine learning models being built and deployed, the ML system may efficiently configure and train a machine learning model using the configuration parameters and the hyper-parameters used previously in other machine learning models. The ML system, therefore, can reduce computer processing resources and processing time for configuring and training a machine learning model significantly without using those repetitive experiments to test suitable configuration parameters and hyper-parameters.

In some embodiments, the ML system may have a datasets database that stores datasets and/or data characteristics derived from the datasets associated with previously-built machine learning models. When the ML system receives a request to build a new machine learning model, the ML system can compare the different machine learning models based on the data stored in the datasets database. The ML system may determine which machine learning model has the highest similarity with the new machine learning model, retrieve configuration and training parameters and hyper-parameters associated with the most similar machine learning model, and then configure and train the new machine learning model according to the retrieved configuration and training parameters. Therefore, analyzing datasets and grouping them (e.g., clustering) may facilitate the machine learning configuration and training process by efficiently selecting the optimal configuration and training parameters for the machine learning model.

In some embodiments, as the ML system is building the first machine learning model (e.g., using the configuration and training parameters determined using the techniques disclosed herein) or after the ML system has built the first machine learning model, the ML system may also apply the datasets associated with the first machine learning model to an experiment-based machine learning training process (e.g., the conventional machine learning model configuration and training process discuss herein). For example, by experimenting with different machine learning model types, configuration parameters, and training parameters, and evaluating different versions of the first machine learning model, the ML system may also determine a particular machine learning model type, a particular set of configuration parameters, and a particular set of training parameters most suitable for the first machine learning model (e.g., outputs with the highest score and/or the highest accuracy). Specifically, the ML system may perform the experiment-based machine learning training process asynchronously with respect to building the first machine learning model (e.g., after the ML system builds the first machine learning model by analyzing the characteristics derived from the datasets). Then the ML system may pair the outputs (e.g., the most suitable the machine learning model type and the training parameters tested by the experiment-based machine learning training process) with the data characteristics (e.g., measures) derived from the datasets and store the pairing of the outputs and the data characteristics. Since the outputs are generated using the conventional experimental process, the pairing between the outputs and the data characteristics can be stored along with the data associated with other previously-built machine learning models, such that, the ML system may have more reliable references (e.g., measures of datasets associated with a corresponding machine learning model type and training parameters) in the ML system. The new pairing generated for the first machine learning model may then be used by the ML system for building subsequent machine learning models (e.g., used in the comparing and/or the clustering process as discussed herein).

In some embodiments, after building (e.g., configuring and training) the first machine learning model based on the configuration and training parameters determined using the techniques disclosed herein, the ML system may dynamically modify the configurations of the first machine learning model and/or re-train the first machine learning model using a different set of training parameters based on new datasets associated with the first machine learning model. For example, as the first machine learning model is deployed in a production environment, the ML system may use the first machine learning model to perform the task based on new datasets (e.g., new transactions to be classified, etc.). The ML system may then use the newly obtained datasets to re-configure and/or re-train the first machine learning model. When new datasets are obtained, e.g., a newly available training dataset is added to the datasets database for the first machine learning model, the ML system may perform the same process as discussed herein to compare the first machine learning model with other previously-built machine learning models based on the new datasets. The ML system may group the first machine learning model with the same or a different cluster of a machine learning model based on the new datasets. For example, the ML system may derive data characteristics (e.g., measures) from the new datasets for the first machine learning model. If the newly derived data characteristics are the same or similar with the previously derived data characteristics (that is, the new datasets have similar characteristics as the old datasets), the ML system may assign the first machine learning model to the same cluster as before, and may determine that no changes are necessary for the first machine learning model. On the other hand, if the newly derived data characteristics are different from the previously derived data characteristics (that is, the new datasets have different characteristics as the old datasets), the ML system may assign the first machine learning model to a different cluster. In that case, the ML system may determine a different machine learning configuration and training parameters based on the different cluster, and may re-configure and/or re-train the first machine learning model based on the different machine learning configuration and training parameters. Therefore, the ML system may efficiently predict a machine learning model type for a given set of datasets, and also provide a dynamically re-configuration to the machine learning model when the ML system receives new and/or updated datasets.

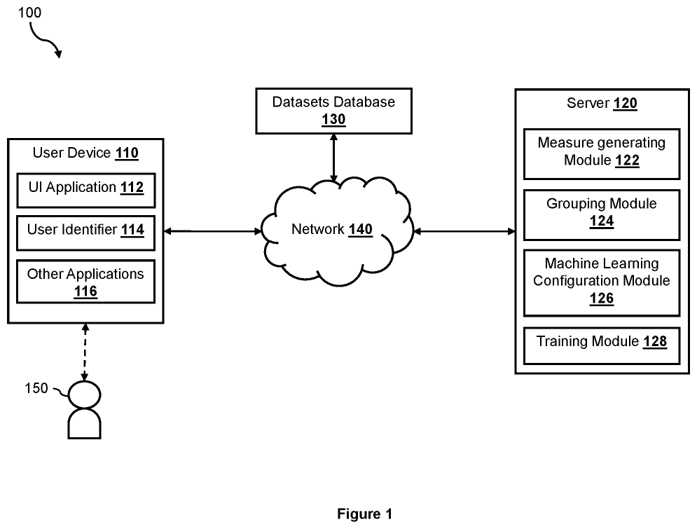

FIG. 1 illustrates an electronic transaction system 100, within which the ML system and the machine learning model configuration framework may be implemented according to one embodiment of the disclosure. The electronic transaction system 100 includes a user device 110, a server 120, and a datasets database 130 that may be communicatively coupled with each other via a network 140. The datasets database 130, in one embodiment, may be a database storing a plurality of data sets usable as input values for various machine learning models (e.g., training data for training the machine learning models, etc.) which are accessible by the server 120. The network 140, in one embodiment, may be implemented as a single network or a combination of multiple networks. For example, in various embodiments, the network 140 may include the internet and/or one or more intranets, landline networks, wireless networks, and/or other appropriate types of communication networks. In another example, the network 140 may comprise a wireless telecommunications network (e.g., cellular phone network) adapted to communicate with other communication networks, such as the Internet.

The user device 110, in one embodiment, includes a user interface (UI) application 112 (e.g., a web browser, a mobile payment application, etc.), which may be utilized by a user 150 to interact with the server 120 over the network 140. In one implementation, the user interface application 112 includes a software program (e.g., a mobile application) that provides a graphical user interface (GUI) for the user 150 to interface and communicate with the server 120 via the network 140. In another implementation, the user interface application 112 includes a browser module that provides a network interface to browse information available over the network 140. For example, the user interface application 112 may be implemented, in part, as a web browser to view information available over the network 140. Thus, the user 150 may use the user interface application 112 to initiate electronic transactions (e.g., login transactions, data access transactions, electronic payment transactions, etc.) with the server 120. For example, the user 150 may, via the user device 110, log into their account and make a payment via the server 120. The server 120 may determine a set of data associated with the payment, such as data provided by the user 150 via the user device 120, data associated with the user device 120 obtained by the server 120, and data generated by the server 120 in association with the payment, etc. For example, the server may determine an account number, the amount of the payment, a transaction history associated with the user device 110, and an IP address of the user device 110. In some embodiments, the inputs regarding the electronic transaction at the user device 110 may be sent to the datasets database 130 as a dataset for configuring and training a machine learning model for a specific task, e.g., a machine learning model for detecting a fraudulent transaction. In one embodiment, the inputs regarding the electronic transaction at the user device 110 may be sent to the server 120 as real-time dataset for re-configuring and training a current machine learning model.

The user device 110, in various embodiments, may include other applications 116 as may be desired in one or more embodiments of the present disclosure to provide additional features available to the user 150. In one example, such other applications 116 may include security applications for implementing client-side security features, programmatic client applications for interfacing with appropriate application programming interfaces (APIs) over the network 140, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the server 120 via the network 140, and the identifier 114 may be used by the server 120 to associate the user 150 with a particular user account (e.g., and a particular profile).

In various implementations, the user 150 is able to input data and information into an input component (e.g., a keyboard) of the user device 110. For example, the user 150 may use the input component to interact with the UI application 112 (e.g., to conduct a purchase transaction via the server 120).

The datasets database 130 may store one or more datasets, for example, including training datasets for training various machine learning models maintained by the server 120, datasets of user profiles, datasets associated with historic transactions, etc. The various machine learning models may be accessible by the server 120, and may be used by the server 120 for performing various tasks. For example, the various machine learning models may include an artificial neural network configured to assess a risk of a login transaction attempt, another artificial neural network configured to predict a product recommendation for a user, a gradient boosting tree configured to analyze a risk of a user device initiating a transaction, a transformer configured to identify a product involved in a transaction, etc. As such, the various machine learning models may include machine learning models of different types. Even when different machine learning models are implemented in the same types, the different machine learning models may be configured using different configuration parameters (e.g., different number of hidden layers, etc.) and may be trained using different training parameters (e.g., different hyper-parameters, etc.). In some embodiments, at least some of the machine learning models were implemented and trained based on a configuration setting and training parameters that are determined to be optimal for the corresponding tasks by experimenting with different configuration settings and training parameters.

Since the various machine learning models are configured to perform different tasks, they are configured to accept input values corresponding to different sets of input features. For example, the input features associated with the artificial neural network configured to assess a risk of a login transaction attempt may be different from the input features associated with the transformer configured to identify a product involved in a transaction.

As discussed herein, the datasets database 130 may include datasets usable as input values for the various machine learning models. Thus, the datasets database 130 may include first datasets for one of the machine learning models. The first datasets may include data values corresponding to the input features associated with that machine learning model. The datasets database 130 may include second datasets for another one of the machine learning models. The second datasets may include data values corresponding to the input feature associated with that other machine learning model. In some embodiments, input features in each of the datasets may overlap, partially overlap, or be mutually exclusive. For example, the first datasets may include data values corresponding to five input features, such as a username, a user account number, an amount of a transaction, a date of the transaction, and an IP address, while the second datasets may include data values corresponding to three input features, such as a user (or sender) account number, an amount of a transaction, and a recipient's account number.

In various embodiments, the datasets in the datasets database 130 may be textual data, image data, and/or sensor data. In one embodiment, the datasets database 130 may include a streaming dataset(s) which is accessible by the server 120 in real time.

The server 120, in various embodiments, may be any of various types of computer servers, e.g., a cluster of computers in a server farm, capable of serving data to other computing devices, including user device 110, via network 140. The server 120 may be associated with different types of entities or systems, such as, but not limited to, various service providers, including payment or transaction service providers. In some embodiments, the server 120 may include a measure generating module 122, a grouping module 124, a machine learning configuration module 126, and a training module 128. Upon receiving a request to build a machine learning model (e.g., a new machine learning model usable by the server, also referred to as the “first machine learning model” hereinafter) for performing a particular task (e.g., classifying transactions into fraudulent and non-fraudulent transactions, etc.), the measure generating module 122 may obtain datasets associated with the first machine learning model. For example, the datasets may be training datasets that are generated and/or obtained specifically to configure and train the machine learning model to perform the particular task. In some embodiments, when a set of input features is determined for the first machine learning model, the datasets may include data values corresponding to the set of input features. As discussed herein, the set of input features associated with the first machine learning model may be different from the input features associated with any one of the previously built machine learning models, which have datasets stored in the datasets database 130. The measure generating module 122 of the server 120 may extract values from each dataset (e.g., extracting values corresponding to a particular input feature from the datasets) and calculate data characteristics (e.g., measures) for the datasets based on the extracted values. The grouping module 124 may then compare the data characteristics calculated for the first machine learning model against data characteristics calculated for the other machine learning models (e.g., the datasets stored in the datasets database 130) and group the datasets based on how similar their measures are. The grouping module 124 may determine that the datasets associated with the first machine learning model may be grouped (e.g., in the same cluster) with datasets associated with a second machine learning model. The machine learning configuration module 126 may then determine a corresponding machine learning configuration setting, e.g., retrieving configuration parameters and hyper-parameters used in the second machine learning model. The machine learning configuration module 126 and the training module 128 may configure the first machine learning model based on the corresponding machine learning model type, e.g., configuring the first machine learning model using the configuration parameters, and tune and train the first machine learning model using the hyperparameters and the datasets.

After configuring and training the first machine learning model, the server 120 may deploy the first machine learning model in a production environment for use in performing the specific task. As the first machine learning model is used to perform the specific task, new datasets (e.g., data values that were used as input data for the first machine learning model for performing the task) may be obtained. The server 120 may then re-calculate the measures (or update the measures) for the first machine learning model based on the new datasets. In some embodiments, the server 120 may combine the old datasets (used to calculate the original set of measures) with the new datasets, and may calculate (or update) the measures for the first machine learning model based on the combined datasets. In some embodiments, the server 120 may calculate the new measures based solely on the new datasets. In some embodiments, the new measures may trigger a re-configuration and/or re-training of the first machine learning model. For example, if the re-calculated measures for the first machine learning model are determined to be more similar to the measures associated with a different machine learning model than the second machine learning model (e.g., a third machine learning model), the server 120 would determine a new machine learning model type, new configuration parameters, and new hyperparameters to train the machine learning model based on the configuration and training parameters associated with the third machine learning model. The server 120 may then re-configure the first machine learning model (e.g., implement the first machine learning model using the new machine learning model type and the new configuration parameters), and re-train the first machine learning model using the new hyperparameters.

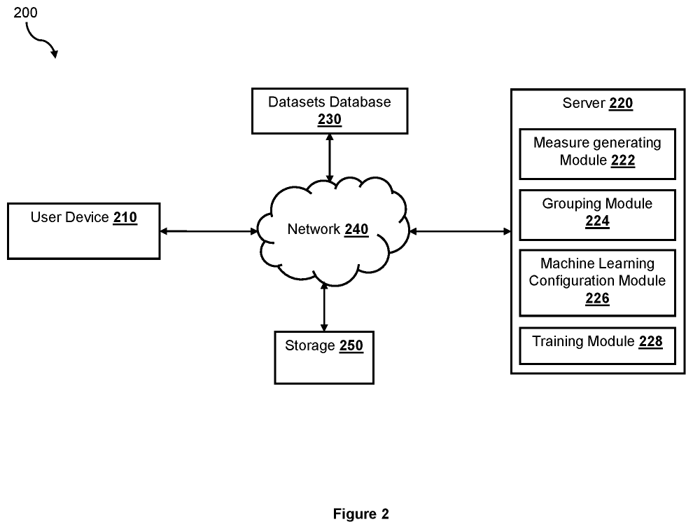

FIG. 2 illustrates a machine learning system 200, within which a machine learning model configuration framework may be implemented according to some embodiments of the disclosure. The machine learning system 200 includes a user device 210, a server 220, a datasets database 230, and a storage 250 that may be communicatively coupled with each other via a network 240. The server 220, the datasets database 230, and the network 240, in one embodiment, may correspond to the server 120, the datasets database 130, and the network 140, respectively, described in FIG. 1. The storage 250, in one embodiment, may be a central repository storing labeled datasets after trainings performed at the server 220 and accessible to the server 220.

The user device 210 may be an internal device within an operational environment of the server 220, the datasets database 230, and the storage 250. The user may use the user device 210 to initiate and operate a machine learning configuring and training process at the server 220. For example, the user may submit a request to build a machine learning model (e.g., a first machine learning model) configured to perform a particular task to the server 220. The server 220 may prompt the user for datasets that are usable as input values for the machine learning model. Thus, the server 220 may obtain datasets associated with the first machine learning model. The server 220 may also retrieve other data, such as historical training data, from the storage 250, in facilitating the machine learning configuring and training process of the first machine learning model.

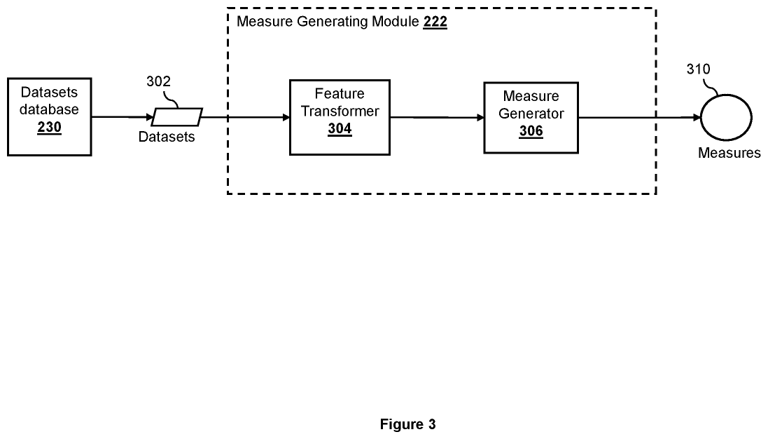

FIG. 3 illustrates an example implementation of the measure generating module 222 according to various embodiments of the disclosure. As shown, the measure generating module 222 includes a feature transformer 304 and a measure generator 306. The measure generating module 222 may receive datasets 302 (e.g., from the user device 210, from the datasets database 130, etc.). The datasets 302 may be usable for a machine learning model (e.g., the first machine learning model). In this example, the first machine learning model may be a model that is requested by the user of the user device 210 to be built for performing a specific task (e.g., classifying transactions as fraudulent transactions or non-fraudulent transactions, etc.). In some embodiments, each of the datasets 302 may correspond to a set of values corresponding to a set of input features of the first machine learning model, and usable as input values for the first machine learning model to perform the corresponding task. The measure generating module 222 may analyze the datasets 302 and generate data characteristics (e.g., measures) for the first machine learning model based on the datasets 302.

In some embodiments, the feature transformer 304 of the measure generating module 222 may obtain the datasets 302, extract values from each of the datasets 302 corresponding to a feature, and send the values to the measure generator 306. In one example, the feature transformer 304 may determine that the first machine learning model is associated with five input features, e.g., an account number, an IP address of a user device, an amount associated with a transaction, a location of a user device, and a transaction type of the transaction. Thus, each of the datasets 302 may include five data values, corresponding to the five input features. For each feature, the feature transformer 304 may extract a value corresponding to the feature, e.g., 5000 which represents an amount of transaction of $5,000. The feature transformer 304 may then send all extracted values which represent all features in every dataset in the first plurality of datasets 302 to the measure generator 306.

In some embodiments, the measure generator 306 may extract, from each dataset in the datasets 302, a data value corresponding to an input feature, and calculate measures based on the extracted data values. For example, the measure generator 306 may extract all values corresponding to the “account number” input feature from the datasets 302, and may calculate the measures based on the account number values from the datasets 302. As discussed herein, the measures may include one or more central tendency measures (e.g., an expectation, a median, a mode, etc.), one or more spread measures (e.g., a range, a quantile, an interquartile range, a variance and standard deviation, etc.), one or more basic statistical measures (e.g., a maximum/a minimum value, a storage type, a dimension, a count, etc.), one or more pattern measures (e.g., symmetrical or asymmetrical, a distribution attribute, etc.), one or more frequency measures (e.g., a ratio, a rate, etc.), one or more outlier measures (e.g., a presence of an outlier, etc.), and/or one or more correlations among different measures. As such, the measure generator 306 may calculate, for the “account number” input feature, one or more central tendency measures, one or more spread measures, one or more basic statistical measures, one or more pattern measures, one or more frequency measures, one or more outlier measures, and/or one or more correlations among different measures. The measure generator 306 may also perform the same process to calculate measures for the remaining input features associated with the first machine learning model, and produce the measures 310 for all of the input features associated with the first machine learning model.

In some embodiments, the measure generating module 222 may use the same techniques as disclosed herein to generate measures for other machine learning models based on the datasets corresponding to the other machine learning models stored in the dataset database 230.

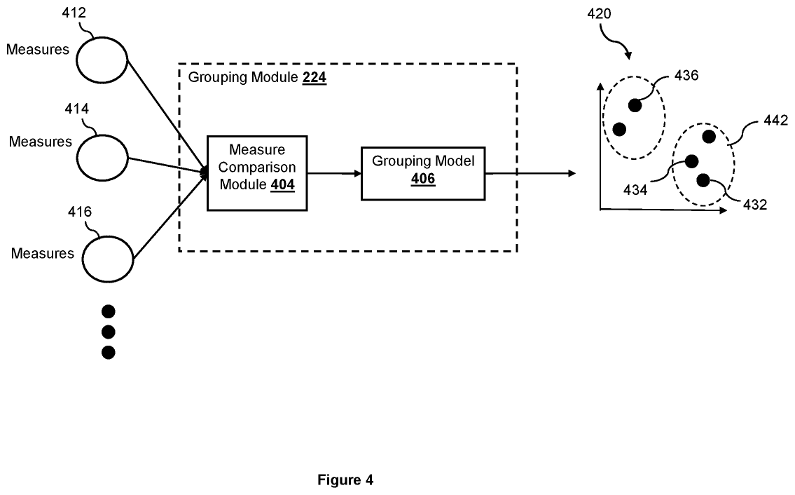

FIG. 4 illustrates an example implementation of the grouping module 224 according to various embodiments of the disclosure. As shown, the grouping module 224 includes a measure comparison module 404 and a grouping model 406. In some embodiments, the measure comparison module 404 may receive various sets of measures that have been generated by the measure generating module 222, including measures 412, measures 414, measures 416, and others. Each of the measures 412, 414, and 416 may be generated for a different machine learning model based on the corresponding datasets. For example, the measures 412 may correspond to the measures 310 generated for the first machine learning model based on the datasets 302, the measures 414 may be generated for a second machine learning model (e.g., one of the machine learning models that has been previously built by the server 220 or another computer system) based on datasets associated with the second machine learning model, and the measures 416 may be generated for a third machine learning model (e.g., another one of the machine learning models that has been previously built by the server 220 or another computer system) based on datasets associated with the third machine learning model. In some embodiments, the measure comparison module 404 may compare the measures 412 against each of the measures 414 and 416 to determine which measures are similar to the measures 412 by a threshold.

In some embodiments, the measure comparison module 404 may compare each measure in the measures 412 against every measure in the measures 414 to determine a similarity between them. As discussed herein, since the input features associated with the first machine learning model may be different (e.g., partially overlapping or completely non-overlapping) from the input features associated with the second machine learning model, an input feature associated with the first machine learning model may not correspond to any input feature associated with the second machine learning model. However, even if the input features are different (e.g., account number vs. a social security number, etc.), the data characteristics between the two input features may be comparable. From the perspective of a machine learning model, the two input features may be treated in a similar way even though they are different input features as long as the data characteristics of the corresponding values are similar. Thus, the grouping module 224 may compare the measures calculated for a first input feature associated with the first machine learning model against measures calculated for each input feature associated with the second machine learning model separately, regardless of whether the two input features correspond to the same feature.

In one example, the measures 412 may include ten measures for each input feature associated with the first machine learning model, and the measures 414 may also include ten measures for each input feature associated with the second machine learning model. The measure comparison module 404 may compare the ten measures calculated for a first input feature of the first machine learning model against the ten measures calculated for each of the input features of the second machine learning model. The measure comparison module 404 may then compare the ten measures calculated for a second input feature of the first machine learning model against the ten measures calculated for each of the input features of the second machine learning model, compare the ten measures calculated for a third input feature of the first machine learning model against the ten measures calculated for each of the input features of the second machine learning model, and so forth. The measure comparison module 404 may then compute a similarity score for each of the other machine learning models based on the comparison (e.g., the differences among the measures, etc.). In some embodiments, the measure comparison module 404 may select, among the previously-built machine learning models, a machine learning model (e.g., the second machine learning model) having the highest similarity score for determining the configuration settings and training parameters for the first machine learning model.

In some embodiments, the grouping module 224 may determine similarities among the measures 412, 414, and 416 using a clustering technique. For example, the grouping module 224 may use the grouping model 406 (which may be a machine learning model) to map each of the machine learning models to a vector (or position) in a multi-dimensional space 420 based on the corresponding measures (e.g., the measures 412, the measures 414, the measures 416, etc.). In some embodiments, the grouping model 406 may be configured and trained to accept the measures associated with a machine learning model as input values, and produce an output that represents a vector or a position (e.g., a coordinate) in the multi-dimensional space 420. For example, the grouping model may map the first machine learning model to a position 432 in the multi-dimensional space 420 based on the measures 412, map the second machine learning model to a position 434 in the multi-dimensional space 420 based on the measures 414, and map the third machine learning model to a position 436 in the multi-dimensional space 420 based on the measures 416. The grouping model 406 may map other machine learning models to various positions in the multi-dimensional space 420 based on their corresponding measures. As shown in FIG. 4, the multi-dimensional space 420 includes different marked positions (e.g., including the positions 432, 434, and 436) representing the measures associated with the different machine learning models. The measure comparison module 404 may then perform one or more clustering operations for the machine learning models based on their corresponding positions in the multi-dimensional space 420. The clustering operations may include using clustering algorithms such as centroid-based clustering algorithms, density-based clustering algorithms, distribution-based clustering algorithms, and hierarchical clustering algorithms. Examples of the centroid-based clustering algorithms may include k-means algorithm and k-medoids algorithm. Examples of the density-based clustering algorithms may include density-based spatial clustering of applications with noise (DBSCAN) and ordering points to identify the clustering structure (OPTICS). Examples of the distribution-based clustering algorithms may include gaussian mixture model algorithm and mean-shift clustering algorithm. Examples of the hierarchical clustering algorithms may include agglomerative clustering algorithm and the balance iterative reducing and clustering using Hierarchies (BIRCH).

The clustering operations may assign each of the machine learning models to a cluster based on the corresponding mapped positions in the multi-dimensional space 420. In some embodiments, the machine learning models may be assigned to the same cluster when the mapped positions are close together, and the machine learning models may be assigned to different clusters when the mapped positions are far away from each other. In this example, the clustering operations may assign the first machine learning model and the second machine learning model to the same cluster (e.g., a cluster 442) based on the positions 432 and 434 being close to each other in the multi-dimensional space 420, while assigning the third machine learning model to another cluster 436 based on the position 436 being farther away from the positions 432 and 434.

In some embodiments, the grouping module 224 may determine the cluster (e.g., the cluster 442) to which the first machine learning model is assigned. The grouping module 224 may then select a machine learning model (e.g., the second machine learning model) that is mapped to the same cluster as the first machine learning model in the multi-dimensional space 420 for determining the configuration settings and training parameters for the first machine learning model.

Referring back to FIG. 2, after selecting a machine learning model (e.g., the second machine learning model) that is most similar to the first machine learning model, the machine learning configuration module 226 may determine the configuration settings that were used to implement the second machine learning model (e.g., the machine learning model type of the second machine learning model, configuration parameters used to implement the second machine learning model, etc.). In some embodiments, the machine learning configuration module 226 may configure the first machine learning model using the same configuration settings as the second machine learning model. The training module 228 may determine the configuration and training parameters (e.g., hyper-parameters) used to configure and train the second machine learning model, and may use the same configuration and training parameters to configure and train the first machine learning model. In some embodiments, the training module 228 may use the datasets 302 to configure and train the first machine learning model. Since the data characteristics of the input data associated with the first machine learning model and the second machine learning model are similar, the settings and parameters that work well for the second machine learning model (through experimentations done when building the second machine learning model) should also work for the first machine learning model (e.g., would enable the first machine learning model to perform the task with an accuracy performance above a threshold, etc.).

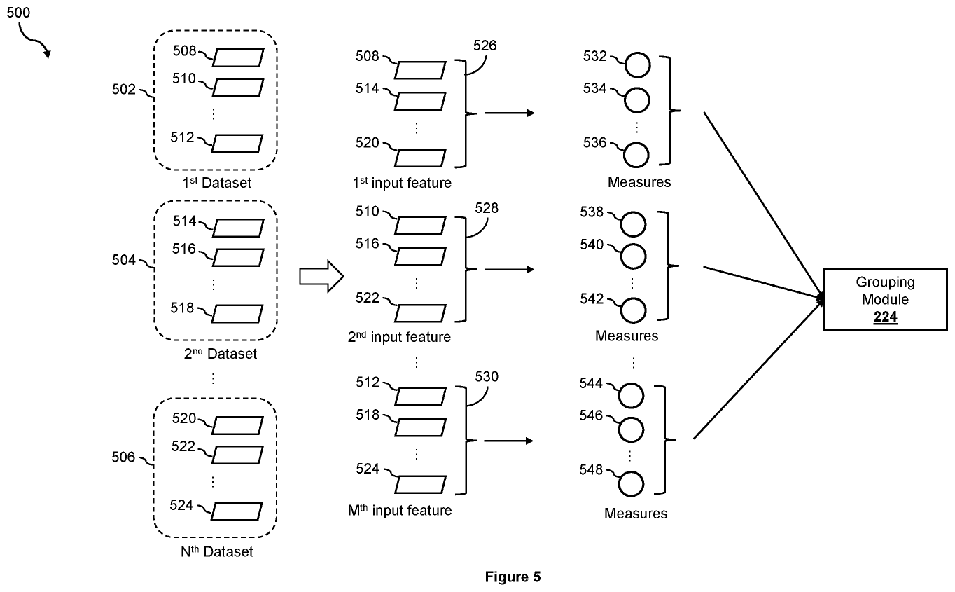

FIG. 5 illustrates an example data flow 500 for calculating measures according to various embodiments of the disclosure. In some embodiments, the example data flow 500 may be performed by the measure generating module 222. In a process of calculating measures for a particular machine learning model, based on the datasets associated with the particular machine learning model, the measure generating module 222 may obtain N datasets usable as input values for the particular machine learning model (e.g., training data sets for the particular machine learning model), including a first dataset 502, a second dataset 504 . . . , and a N^{th} dataset 506. Each of the datasets may include M data values corresponding to M input features associated with the particular machine learning model. For example, the first dataset 502 may include a value 508 corresponding to the first input feature, a second value 510 corresponding to the second input feature . . . , and a value 512 corresponding to the M^{th} input feature. The second dataset 504 may include a value 514 corresponding to the first input feature, a value 516 corresponding to the second input feature . . . , and a value 518 corresponding to the M^{th} input feature. The N^{th} dataset 506 may include a value 520 corresponding to the first input feature, a value 522 corresponding to the second input feature . . . , and a value 524 corresponding to the M^{th} input feature.

To calculate measures for each input feature for the particular machine learning model, the measure generating module 222 may group values from the datasets (e.g., the data sets 502, 504, 506, etc.) corresponding each input feature. For example, the measure generating module 222 may obtain values corresponding to the first input feature (e.g., the values 508, 514 . . . , and 520) from the datasets to form a group 526 associated with the first input feature. The measure generating module 222 may also obtain values corresponding to the second input feature (e.g., the values 510, 516 . . . , and 522) from each dataset to form another group 528 associated with the second input feature. The measure generating module 222 may continue to obtain values from the datasets that correspond to other input features and form additional groups until M groups of values are formed. Thus, the measure generating module 222 may complete the groups by obtaining values corresponding to the M^{th} input feature (e.g., the values 512, 518 . . . , and 524) from the datasets to from a group 530 associated with the M^{th} input feature. The measure generating module 222 may then calculate a set of measures for each of the input features based on the values in the corresponding groups 526, 528, 530, etc. For example, the measure generating module 122 may calculate measures 532, 534 . . . , and 536 for the first input feature based on the values in the first group 526, calculate measures 538, 540 . . . , and 542 for the second input feature based on the values in the group 528, and continue to calculate measures for the different input features until it finishes calculating the measures 544, 546 . . . , and 548 for the M^{th} input feature based on the values in the group 530. The measure generating module 222 may use the techniques illustrated herein to calculate measures for the various machine learning models. The measures may then be used by the grouping module 224 to determine similarities between the machine learning models.

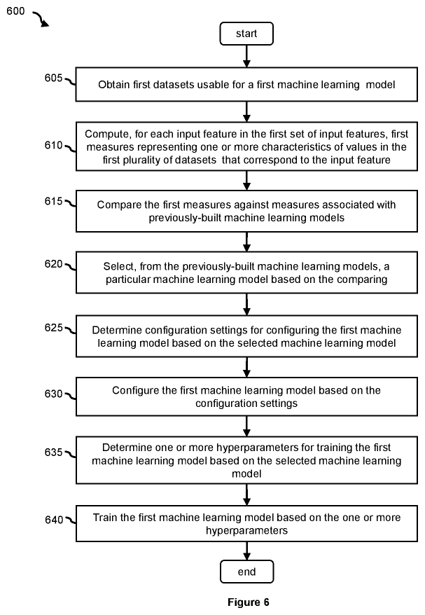

FIG. 6 illustrates an example process 600 for configuring and training a machine learning model using the machine learning model configuration framework according to various embodiments of the disclosure. In some embodiments, at least a portion of the process 600 may be performed by the measure generating module 222, the grouping module 224, the machine learning configuration module 226, and/or the training module 228. The process 600 begins by obtaining (at step 605) first datasets usable for a first machine learning model. For example, the measure generating module 222 may obtain the datasets 302 from the datasets database 230, and each dataset in the first plurality of datasets 302 may include a set of values corresponding to input a first set of input features associated with the first machine learning model (e.g., account number, transaction amount, IP address, etc.). In some embodiments, the first datasets may include training datasets usable for training the first machine learning model.

The process 600 computes (at step 610), for each input feature the first set of input features, first measures representing one or more characteristics of values in the first plurality of datasets that correspond to the input feature. For example, the measure generating module 222 may extract, from the first datasets, data values corresponding to a first input feature in the first set of input features. When the input feature is an account number input feature, the measure generating module 222 may extract an account number value from each of the first datasets. In one embodiment, each of the data values may be obtained/extracted from a distinct dataset from the first datasets. The measure generating module 222 may then calculate one or more measures for the input feature based on the extracted data values. As discussed herein, the one or more measures may represent characteristics (e.g., statistical characteristics) of the extracted data values as a whole. Thus, the measure generating module 222 of some embodiments may perform one or more statistical analyses based on the extracted data values, and generate the measures based on the one or more statistical analyses. For example, the measure generating module 222 may calculate a median based on the extracted data values. In some embodiments, the one or more measures may include at least one of a central tendency of the extracted data values, a skewness of the extracted data values, a spread among extracted data values, one or more patterns derived from the extracted data values, a frequency of any value from the extracted data values, a presence of outliers in the extracted data values, a correlation between different measures calculated for the input feature, and a type of probability distribution of the extracted data values. In some embodiments, the measure generating module 222 may perform the same process to calculate measure for the remaining input features associated with the first machine learning model.

The process 600 then compares (at step 615) the first measures against measures associated with previously built machine learning models. For example, the measure generating module 222 may obtain datasets associated with machine learning models that have been previously built and deployed by the server 220. Those datasets may include training datasets used for configuring and training the machine learning models and/or historical datasets used as input data for the machine learning models to perform the corresponding tasks. The measure generating module 222 may use the same techniques as disclosed herein to calculate measures for each of the machine learning models (e.g., calculating one or more measures for each input feature associated with each of the machine learning models). In some embodiments, the grouping module 224 may compare the measures associated with the first machine learning model against measures associated with each of the previously built machine learning models to determine which of the previously built machine learning model has the most similar data characteristics as the first machine learning model. For example, the measure generating module 222 may compare the measures 412 against each one of the measures 414 and 416 associated with the different previously built machine learning models. The grouping module 224 may compare a first measure (e.g., a median calculated for a first input feature of the first machine learning model, etc.) from the measures 412 against a second measure (e.g., a median calculated for a second input feature of a second machine learning model, etc.) from the measures 414. The grouping module 224 may continue to compare other measures between the measures 412 and the measures 414, and may calculate a similarity score for the machine learning model (e.g., a second machine learning model) that is associated with the measures 414, indicating a similarity level between the data characteristics associated with the first machine learning model and the data characteristics associated with the second machine learning model.

In some embodiments, the grouping module 224 may use one or more clustering algorithms to cluster the first machine learning model and the previously built machine learning models based on the measures generated for the respective models. For example, the grouping module 224 may map each of the machine learning models to a vector (or a position) within a multi-dimensional space. The grouping module 224 may then assign each of the machine learning models to a cluster within the multi-dimensional space based on the corresponding mapped position for the machine learning model and one or more clustering parameters.

The process 600 then selects (at step 620), from a plurality of the previously built machine learning models, a particular machine learning model based on the comparing. For example, the grouping module 224 may select a machine learning model (e.g., the second machine learning model) having the highest similarity score. In the example where the machine learning models are all mapped to vectors (or positions) within the multi-dimensional space, the grouping module 224 may identify a cluster to which the first machine learning model is assigned. The grouping module 224 may then select a machine learning model (e.g., the second machine learning model) within the same cluster as the first machine learning model.

The process 600 determines (at step 625) configuration settings for configuring the first machine learning model and configures (at step 630) the first machine learning model based on the configuration settings. For example, the machine learning configuration module 226 may determine the configuration settings for the first machine learning model based on the selected machine learning model. In some embodiments, the machine learning configuration module 226 may select from different machine learning model types (e.g., an artificial neural network, a gradient boosting tree, etc.), a particular machine learning model type for the first machine learning model, and select, from different configuration parameters (e.g., how many hidden layers in an artificial neural network, how many levels of models within each level in a gradient boosting tree, etc.), a particular set of configuration parameters based on the selected machine learning model. For example, the machine learning configuration module 226 may determine a machine learning model type of the selected machine learning model and configuration parameters used to configure the selected machine learning model. The machine learning configuration module 226 may then configure the first machine learning model based on the configuration settings of the selected machine learning model.

The process 600 then determines (at step 635) one or more hyperparameters for training the first machine learning model based on the selected machine learning model and trains (at step 640) the first machine learning model based on the plurality of one or more hyperparameters. For example, the training module 228 may determine hyperparameters used for training the selected machine learning model, and may train the first machine learning model using the first datasets 302 based on the hyperparameters.

In some embodiment, the process 600 may further obtain a third plurality of datasets for configuring and training the first machine learning model, update the first set of measures based on the third plurality of datasets, select, from the plurality of machine learning model types, a second machine learning model type for the first machine learning model based on the updated first set of measures, re-configure the first machine learning model based on the second machine learning model type, determine a second plurality of hyperparameters for training the first machine learning model based on the updated first set of measures, and train the re-configured first machine learning model using at least one of the first plurality of datasets or the third plurality of datasets based on the second plurality of hyperparameters. For example, the server 220 may receive a real-time dataset via the network 240 from an external server, or from the datasets database 230 or the user device 210, and the measure generating module 222 may generate a third set of measures for the real-time dataset using the same process described in steps 610 and 615, and the grouping module 224 may update the first set of measures 310 based on the third set of measures to select another machine learning model type accordingly. In one embodiment, the server 220 may utilize a sliding window algorithm to support real time calculations to update the measures. The machine learning configuration module 226 and the training module 228 may further re-configure the first machine learning model using another machine learning model type, tune the first machine learning model using updated hyperparameters determined based on the re-configuration, and train and monitor the first machine learning model using the real-time dataset.

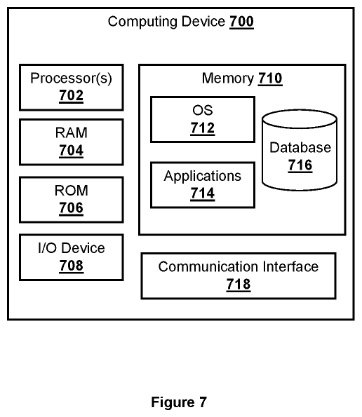

FIG. 7 illustrates a computing device 700 that may be used to implement the servers 120 and 220, the user devices 110 and 210, the datasets databases 130 and 230, and the storage 250 according to various embodiments of the disclosure. The computing device 700 may include a processor 702 for controlling overall operation of the computing device 700 and its associated components, including a random access memory (RAM) 704, a read only memory (ROM) 706, an input/output (I/O) device 708, a communication interface 718, and/or a memory 710. A data bus may interconnect the processor(s) 702, the RAM 704, the ROM 706, the memory 710, the I/O device 708, and/or the communication interface 718. In some embodiments, the computing device 700 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

The input/output (I/O) device 708 may include a microphone, keypad, touch screen, and/or stylus motion, gesture, through which a user of the computing device 700 may provide input. The I/O device 708 may also include one or more of a speaker for providing audio output and a video display device for providing textual, audiovisual, and/or graphical output. Software may be stored within the memory 710 to provide instructions to the processor(s) 702 allowing the computing device 700 to perform various actions. For example, the memory 710 may store software used by the computing device 700, such as an operating system (OS) 712, application programs 714, an associated internal database 716, and/or any software that implements the process 600 as described herein. The various hardware memory units in the memory 710 may include volatile and nonvolatile, removable and non-removable media implemented in any method or technology for storage of information such as computer-readable instructions, data structures, program modules, or other data. The memory 710 may include one or more physical persistent memory devices and/or one or more non-persistent memory devices. The memory 710 may include, but is not limited to, a RAM, a ROM, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by the processor(s) 702.

The communication interface 718 may include one or more transceivers, digital signal processors, and/or additional circuitry and software for communicating via any network, wired or wireless, using any protocol as described herein.

The processor(s) 702 may include a single central processing unit (CPU), e.g., a single-core or multi-core processor, or may include multiple CPUs. The processor(s) 702 and associated components may allow the computing device 700 to execute a series of computer-readable instructions to perform some or all of the processes described herein. Although not shown in FIG. 7, various elements within the memory 710 or other components in computing device 700, may include one or more caches, for example, CPU caches used by the processor(s) 702, page caches used by the operating system 712, disk caches of a hard drive, and/or database caches used to cache content from the database 716. In various embodiments, the database 716 may be the datasets database 230 described in FIG. 2. For embodiments including a CPU cache, the CPU cache may be used by the processor(s) 702 to reduce memory latency and access time. The processor(s) 702 may retrieve data from or write data to the CPU cache rather than reading/writing to the memory 710, which may improve the speed of these operations. In some embodiments, a database cache may be created in which certain data from the database 716 is cached in a separate smaller database in a memory separate from the database 716, such as in the RAM 704 or on a separate computing device. For instance, in a multi-tiered application, a database cache on an application server may reduce data retrieval and data manipulation time by not needing to communicate over a network (e.g., the network 140 described in FIG. 1) with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 700 are described separately, functionality of the various components may be combined and/or performed by a single component and/or multiple computing devices in communication without departing from the invention.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
obtaining a first plurality of datasets usable for training a first machine learning model, wherein each dataset in the first plurality of datasets comprises a set of values corresponding to a first set of features;
computing, for the first set of features, a first set of measures representing one or more statistical characteristics of values in the first plurality of datasets;
comparing the first set of measures against a second set of measures computed based on a second plurality of datasets used for training a second machine learning model;
selecting, from a plurality of machine learning model types, a particular machine learning model type for the first machine learning model based on the comparing;
configuring the first machine learning model based on the particular machine learning model type;
determining a set of hyperparameters for training the first machine learning model based on the comparing; and
training the first machine learning model using the first plurality of datasets and based on the set of hyperparameters.

2. The system of claim 1, wherein the computing the first set of measures comprises:
obtaining, from the first plurality of datasets, data values corresponding to a first feature in the first set of features, wherein each of the data values is obtained from a distinct dataset from the first plurality of datasets;
deriving a statistical value from the data values; and
computing a first measure in the first set of measures that corresponds to the first feature based on the statistical value.

3. The system of claim 1, wherein the comparing the first set of measures against the second set of measures comprises:
applying the first set of measures and the second set of measures to a grouping algorithm as inputs;
comparing the first set of measures against the second set of measures; and
determining a relationship between the first plurality of datasets and the second plurality of datasets based on the comparing.

4. The system of claim 1, wherein the operations further comprise:
obtaining a third plurality of datasets usable for training the first machine learning model;
updating the first set of measures based on the third plurality of datasets;
selecting, from the plurality of machine learning model types, a second machine learning model type for the first machine learning model based on the updated first set of measures;
re-configuring the first machine learning model based on the second machine learning model type;
determining a second plurality of hyperparameters for training the first machine learning model based on the updated first set of measures; and
training the re-configured first machine learning model using at least one of the first plurality of datasets or the third plurality of datasets based on the second plurality of hyperparameters.

5. The system of claim 1, wherein the second set of measures corresponds to a second set of features different from the first set of features.

6. The system of claim 1, wherein the operations further comprise:
configuring and training a plurality of different versions of the first machine learning model generated using different ones of the plurality of machine learning model types, a plurality of configuration parameters, and a plurality of hyperparameters;
evaluating the plurality of different versions of the first machine learning model;
determining a configuration and training setting for the first machine learning model based on the evaluating; and
associating the configuration and training setting with the first set of measures.

7. The system of claim 1, wherein the first set of measures comprise at least one of statistical features of the first plurality of datasets, a central tendency of the first plurality of datasets, a skewness of the first plurality of datasets, a spread among datasets in the first plurality of datasets, one or more patterns of the first plurality of datasets, a frequency of a value in the first plurality of datasets, a presence of outliers in the first plurality of datasets, a correlation between every two measures in the first set of measures, or a type of probability distribution of the first plurality of datasets.

8. A method, comprising:
obtaining a first plurality of datasets usable for training a first machine learning model, wherein each dataset in the first plurality of datasets comprises a set of values corresponding to a first set of features;
computing, for the first set of features, a first set of measures representing one or more data characteristics of values in the first plurality of datasets;
comparing the first set of measures against a second set of measures computed based on a second plurality of datasets used for training a second machine learning model;
determining a configuration for configuring the first machine learning model based on the comparing;
configuring the first machine learning model based on the configuration; and
training the first machine learning model using the first plurality of datasets and based on the configuration.

9. The method of claim 8, wherein the determining the configuration comprises selecting, from a plurality of machine learning model types, a particular machine learning model type for configuring the first machine learning model based on the comparing.

10. The method of claim 8, wherein the computing the first set of measures comprises:
obtaining, from the first plurality of datasets, data values corresponding to a first feature in the first set of features, wherein each of the data values is obtained from a distinct dataset from the first plurality of datasets;
deriving a statistical value from the data values; and
computing a first measure in the first set of measures that corresponds to the first feature based on the statistical value.

11. The method of claim 8, wherein the comparing the first set of measures against the second set of measures comprises:
applying the first set of measures and the second set of measures to a grouping algorithm as inputs;
comparing the first set of measures against the second set of measures; and
determining a relationship between the first plurality of datasets and the second plurality of datasets based on the comparing.

12. The method of claim 8, further comprising:
obtaining a third plurality of datasets for training the first machine learning model;
updating the first set of measures based on the third plurality of datasets;
determining a second configuration for re-configuring the first machine learning model based on the updated first set of measures;
re-configuring the first machine learning model based on the second configuration; and
training the re-configured first machine learning model using at least one of the first plurality of datasets or the third plurality of datasets based on the second configuration.

13. The method of claim 8, wherein the second set of measures corresponds to a second set of features different from the first set of features.

14. The method of claim 8, further comprising:
configuring and training a plurality of different versions of the first machine learning model generated using different ones of a plurality of configurations;
evaluating the plurality of different versions of the first machine learning model;
determining a configuration and training setting for the first machine learning model based on the evaluating; and
associating the configuration and training setting with the first set of measures.

15. A non-transitory machine-readable medium having stored thereon machine-readable instructions executable to cause a machine to perform operations comprising:
obtaining a first machine learning model which is configured and trained using a first plurality of datasets and a first machine learning model type, wherein each dataset in the first plurality of datasets comprises a set of values corresponding to a first set of features;
obtaining a second plurality of datasets usable for training the first machine learning model, wherein each dataset in the second plurality of datasets comprises a set of values corresponding to a second set of features;
computing, for the first set of features and the second set of features, a first set of measures representing one or more statistical characteristics of values in the first plurality of datasets and the second plurality of datasets;
comparing the first set of measures against an original set of measures computed based on the first plurality of datasets;
selecting, from a plurality of machine learning model types, a second machine learning model type for the first machine learning model based on the comparing;
re-configuring the first machine learning model based on the second machine learning model type;
determining a set of hyperparameters for training the first machine learning model based on the comparing; and
re-training the first machine learning model using the first plurality of datasets and the second plurality of dataset and based on the set of hyperparameters.

16. The non-transitory machine-readable medium of claim 15, wherein the computing the first set of measures comprises:
obtaining, from the first plurality of datasets and the second plurality of datasets, data values corresponding to a first feature in the first set of features and the second set of features, wherein each of the data values is obtained from a distinct dataset from the first plurality of datasets and the second plurality of datasets;
deriving a statistical value from the data values; and
computing a first measure in the first set of measures that corresponds to the first feature based on the statistical value.

17. The non-transitory machine-readable non-transitory machine-readable medium of claim 15, wherein the comparing the first set of measures against the original set of measures comprises:
applying the first set of measures and the original set of measures to a grouping algorithm as inputs;
comparing the first set of measures against the original set of measures; and
determining a relationship between the first plurality of datasets and the original plurality of datasets based on the comparing.

18. The non-transitory machine-readable medium of claim 15, wherein the original set of measures is computed by:
obtaining, from the first plurality of datasets, data values corresponding to a first feature in the first set of features, wherein each of the data values is obtained from a distinct dataset from the first plurality of datasets;
deriving a statistical value from the data values; and
computing a first measure in the first set of measures that corresponds to the first feature based on the statistical value.

19. The non-transitory machine-readable medium of claim 15, wherein the second set of features are different from the first set of features.

20. The non-transitory machine-readable medium of claim 15, wherein the operations further comprise:
configuring and training a plurality of different version of the first machine learning model generated using different ones of the plurality of machine learning model types, a plurality of configuration parameters, and a plurality of hyperparameters;
evaluating the plurality of different versions of the first machine learning model;
determining a configuration and training setting for the first machine learning model based on the evaluating; and
associating the configuration and training setting with the first set of measures.
